(19) United States
(12) Patent Application Publication
(10) Pub. No.: US 2026/0088552 A1
(43) Pub. Date: Mar. 26, 2026

(54) Cable Holder Assembly

(71) Applicant: NSI-Lynn Electronics, LLC, Huntersville, NC (US)

(72) Inventor: Charles Hoskins, Miamisburg, OH (US)

(73) Assignee: NSI-Lynn Electronics, LLC, Huntersville, NC (US)

(21) Appl. No.: 19/333,086

(22) Filed: Sep. 18, 2025

Related U.S. Application Data
(60) Provisional application No. 63/697,704, filed on Sep. 23, 2024.

(51) Int. Cl. H01R 13/424; H01R 13/426; H01R 13/506; H01R 13/622

(52) U.S. Cl. CPC H01R 13/424; H01R 13/426; H01R 13/506; H01R 13/622

(57) ABSTRACT

A cable holder assembly and methods of use are disclosed. The cable holder assembly has a grommet within which a cable is held. The grommet is held within a receptacle by a series of tabs, the receptacle having threads onto which a nut can be tightened to ensure the grommet is firmly held in place. The receptacle is configured as two receptacle halves, which are affixed to corresponding holder wing elements. The receptacle halves, and by extension the wing holder elements, are held in abutment by the nut. The cable holder assembly ensures that cables are held firmly in place in non-captive cable installations, and can be swapped out with ease.

### CROSS REFERENCE TO RELATED APPLICATIONS

This application claims the benefit of priority under 35 U.S.C. §119(e) to U.S. Provisional Patent Application Ser. No. 63/697,704 filed on Sep. 23, 2024, entitled NON-CAPTIVE CABLE HOLDER ASSEMBLY, the entire contents of which is hereby incorporated by reference.

### BACKGROUND

### 1. Field of the Disclosure

The present disclosure relates to cable holder apparatuses, assemblies and methods of using the same which are particularly well-suited for non-captive cable applications.

### 2. Background of the Related Art

In the field of electronics, and in particular cable management of copper or fiber-optic cables, two main industry standard methods of cable connections exist. Captive connections are those that are intrinsic to a device or assembly, wherein the cable is permanently connected and cannot be removed without damaging the connection. Non-captive connections are typically between ports and terminated cable ends, and can be connected or disconnected at will.

Current electronic installations make use of both captive and non-captive connections. Captive connections, while more secure, result in significantly reduced installation flexibility, and are often installation specific (i.e. a captive connection design used in one installation may not be sufficient for a different installation). On the other hand, non-captive connections allow greater installation flexibility and are often the same from installation to installation (as a non-limiting example, USB ports and requisite cables are identical across millions of devices), but are often less secure.

Accordingly, a new system for installing cables in electronic installations is needed which while including the advantages of prior connections, cures the deficiencies of both captive and non-captive cable connections.

This section is intended to introduce the reader to various aspects of art that may be related to certain features of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

According to some embodiments of the present disclosure, a non-captive cable holder assembly is provided. In an embodiment of the present disclosure, the cable holder assembly is for use with a drop cable. The cable holder assembly includes two holder wing elements which are capable of being separated or rotated with respect to each other. In certain embodiments the wing elements are connected by a hinge. The wing elements in combination form a receptacle which can split into two receptacle halves when the wing elements are rotated with respect to each other. The cable holder assembly also includes a nut, and a grommet designed to hold at least one cable. A method of operation is disclosed wherein a cable is placed within an aperture or slot formed in the grommet, and the grommet is placed within the receptacle. The nut is used to be secure the grommet and at least one cable in place and lock the two holder wing element in place.

The cable holder assembly according to an embodiment of the present disclosure enables a non-captive cable installation, wherein the cable is equipped with a terminated end which protrudes from one side of the cable holder after installation. The cable holder is locked in place in the larger assembly, and as a result, the cable is held firmly in place despite using a non-captive connection. A variety of grommet designs allow for the design to function effectively with any cable type and number of cables. Furthermore, cables can be readily removed and replaced after installation with minimal effort, simply by reversing the method of operation and installing a new cable within the grommet thereafter.

### BRIEF DESCRIPTION OF DRAWINGS

The subject matter, which is regarded as the disclosure, is particularly pointed out in the specification. The foregoing and other features, and advantages of the disclosure are apparent from the following detailed description taken in conjunction with the accompanying drawings in which like reference numerals refer to like elements throughout the different views.

FIG. 1 is an exploded perspective view of the cable holder assembly, according to an embodiment of the present disclosure.

FIG. 2 is an assembled perspective view of the cable holder assembly, according to an embodiment.

FIG. 3 is a top view of the cable holder assembly of FIG. 2.

FIG. 4 is a front view of the cable holder assembly of FIG. 2.

FIG. 5 is a side view of the cable holder assembly of FIG. 2.

FIGS. 6A-I are several embodiments of a grommet to be utilized with the cable holder assembly of the present disclosure.

### DETAILED DESCRIPTION

In the following specification, reference will be made to a number of terms, which shall be defined to have the following meanings.

As used herein, the singular forms “a,” “an,” and “the” include plural references unless the context clearly dictates otherwise. The terms “comprising,” “including,” and “having” are intended to be inclusive and mean that there may be additional elements other than the listed elements. The terms “optional” or “optionally” means that the subsequently described event or circumstance may or may not occur, and that the description includes instances where the event occurs and instances where it does not.

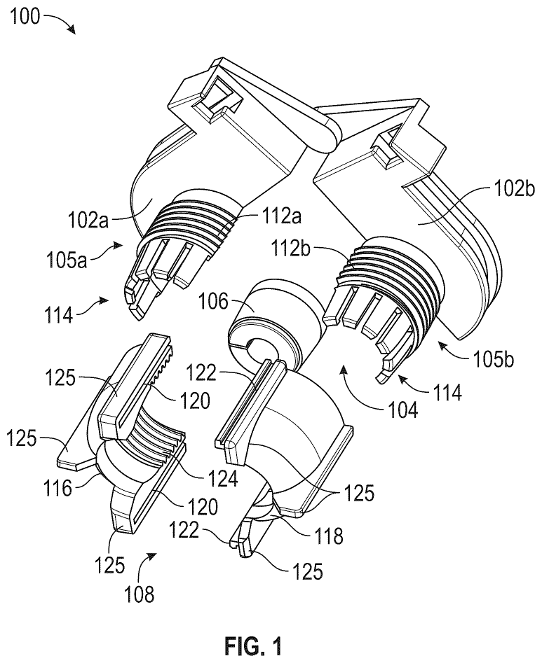

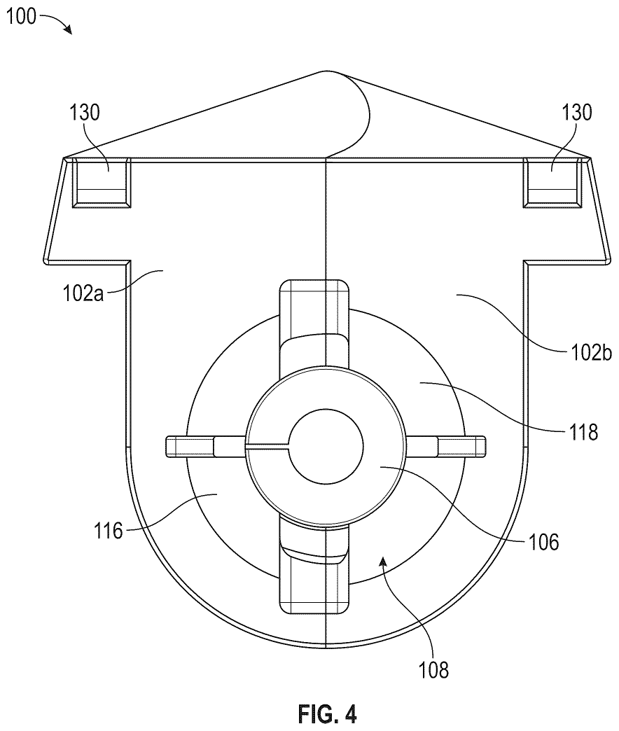

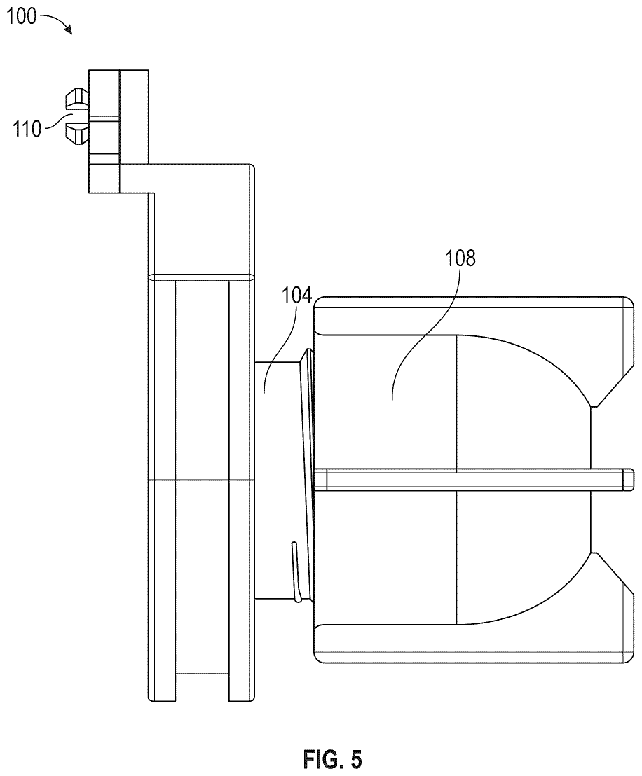

Referring to FIGS. 1-5, a cable holder assembly 100 is shown according to embodiments of the present disclosure. The cable holder assembly 100 includes first and second holder wing elements 102a-b. Each of the holder wing elements 102a/b has a semi-circular receptacle half 105a/b projecting from its front face and in combination the two receptacle halves form a tubular receptacle 104 which defines an interior chamber. The cable holder assembly 100 also includes a grommet 106 and a nut 108.

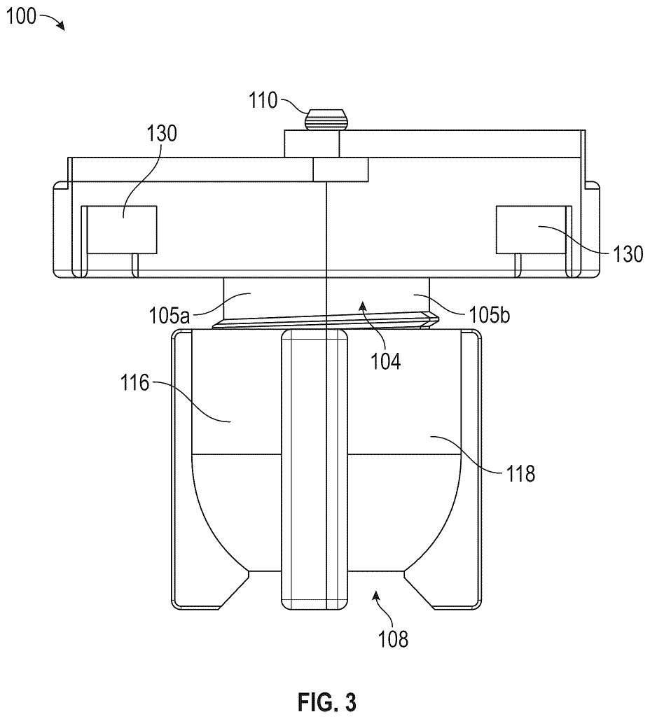

In the embodiment shown in FIGS. 1-5, the first and second holder wing elements 102a-b are connected via a hinge 110 (shown in FIG. 3), which allows the first and second holder wing elements to swing or rotate relative to each other. Those skilled in the art will readily appreciate that the first and second holder wing elements 102a/b can be connected in a variety of ways without departing from the scope of the present invention. In an alternative embodiment, the wing elements 102a-b are not connected but are secured adjacent to each other when the nut 108 is threaded onto the ends of the receptacle halves 105a-b.

As noted above, the receptacle 104 includes receptacle halves 105a-b, which each include a number of partial thread segments 112a-b and tabs 114. Each receptacle half 105a/b extends from the front face of the corresponding holder wing element 102a/b. The thread segments 112a-b of each of the receptacle halves 105a-b are arranged such that when the holder wing elements 102a-b and associated receptacle halves 105a-b are in abutment, the threads segments 112a-b are aligned such that they form a continuous series of male threads about the receptacle 104.

As best shown in FIG. 1, the nut 108 consists of first and second nut sections 116 and 118, respectively. The first and second nut sections 116/118 are roughly semi-circular in cross-section. The upper and lower ends of nut section 116 includes an L-shaped slot 120 which runs longitudinally from its rear end towards its front end. The upper and lower end of nut section 118 include an L-shaped rail element or track 122 which runs longitudinally from its rear end towards its from end. The rail elements or tracks 122 are adapted and configured for sliding engagement within the corresponding slots 120 formed in first nut section 116 so as to form a completed nut 108. Those skilled in the art will readily appreciate that other techniques or mechanisms can be used to join the two nut sections without departing from the scope of the present disclosure.

With continued reference to FIG. 1, each nut section includes segments of threads, such that the assembled nut 108 has a series of female threads 124 formed on its inner diameter. The nut threads 124 are configured such that they correspond with the male threads formed on the receptacle when the nut 108 is screwed on to the receptacle 104. Both nut section 116 and nut section 118 include nut threads 124, but only nut threads 124 on nut section 116 are shown in the figures. The nut 108 also includes longitudinally extending ribs 125 which enable a user to more easily manipulate/thread the nut by providing multiple surfaces for improved finger leverage.

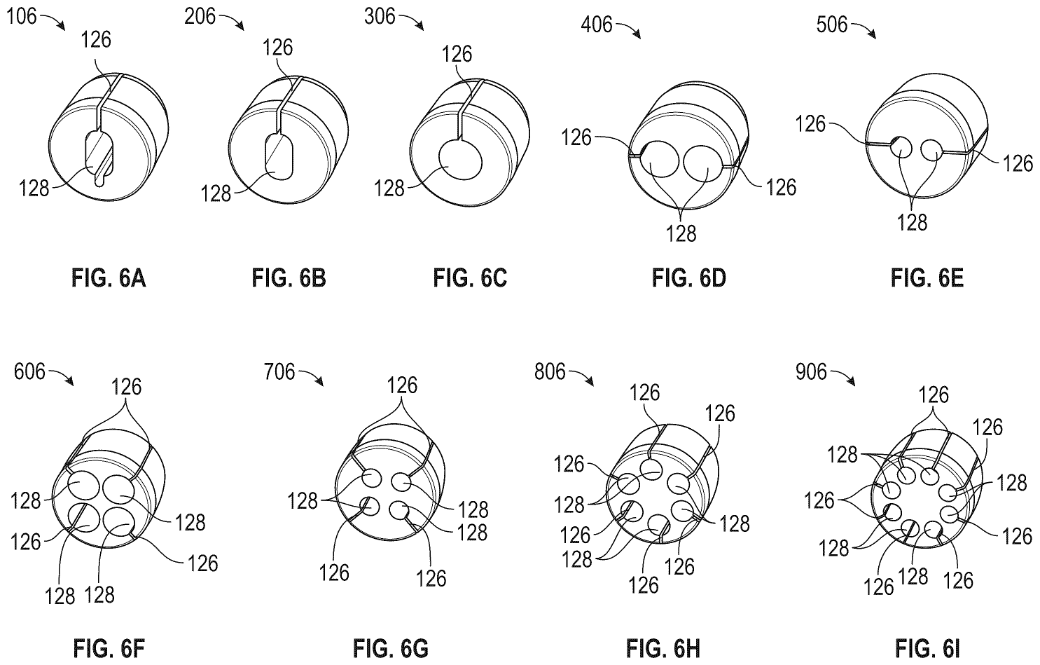

Referring now to FIGS. 6A-I, which illustrate several grommet embodiments 106/206/306/406/506/606/706/806/906 which can be used in the cable holder assembly 100. In certain preferred embodiments, the grommets 106-906 are constructed of an elastomer-type material such as rubber. Those skilled in the art will readily appreciate that other materials can be used to achieve similar properties without departing from the scope of this disclosure.

The grommets 106-906 have a generally cylindrical profile which could include a longitudinal taper. The shape and dimension of the grommets is dictated based on the shape and dimensions of the interior chamber formed in the receptacle. As described above, the receptacle defines a tubular chamber into which a tubular grommet can be placed. However, the receptacle can form a different shaped chamber, for example one with a square cross-section, without departing from the scope of the present invention.

The grommets 106-906 includes at least one slit 126, and at least one bore 128. Each slit 126 forms an access passage between the outer periphery of the grommet and bore 128. Both the bore 128 and the slit 126 are cut/formed through the entire length of the grommet as shown in FIGS. 6A-I. A cable (not shown) can be placed into the bore 128 by pulling on either side of a slit 126, thus widening the slit 126, allowing the cable through the slit 126 and into the bore 128. As shown in FIGS. 6A-I, the grommet 106-906 may include a plurality of slits 126 and bores 128. It is generally preferred that the number of slits equals the number of bores so that each cable will have a dedicated bore to pass through. The bore 128 may be designed to be a variety of shapes which correspond to known cable shapes, typically circular or oval-like.

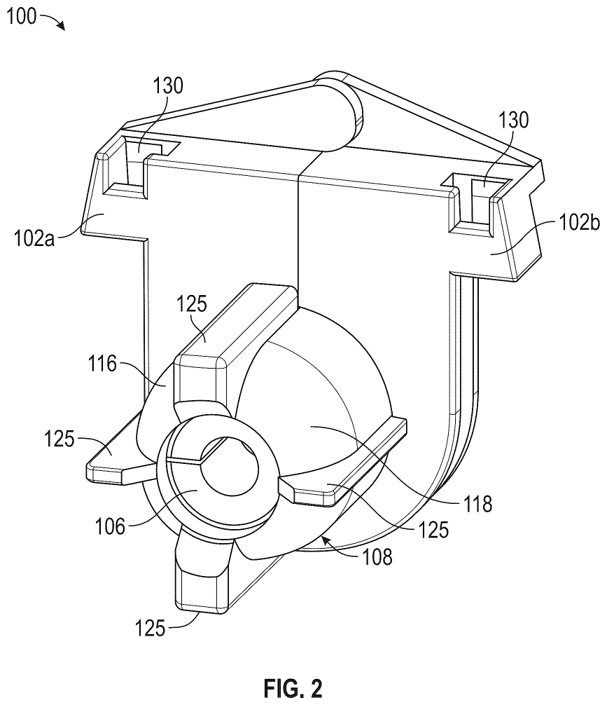

As shown best in FIG. 2, the cable holder 100 further includes clips 130, which are positioned on the cable holder 100 such that it can be snapped into place within a larger assembly (not shown). As a result, the cable holder 100 may be used in semi-permanent electronic installations which would typically require a captive cable. According to an embodiment, the clips 130 function through a snap-fit with a larger assembly. Those skilled in the art will readily appreciate that other techniques can be used for attaching the cable holder 100 to a larger assembly. without departing from the scope of the present invention.

FIGS. 3-5 provide additional viewing angles of the cable holder 100 when fully assembled.

According to an embodiment, a method of operation of the cable holder includes first inserting the cable(s) or wire(s) into the bore 128 of a grommet 106 as discussed above. Referring to FIG. 1, the holder wing elements 102a-b are separated such that the grommet can be inserted into the receptacle 104. The holder wing elements 102a-b are then rotated back into abutment (as shown in FIG. 2), and the grommet is held loosely within the receptacle 104. Then, the nut 108 is assembled by slidably engaging the slots 120 and the rail elements or tracks 122 as described above. The nut 108 must be assembled about the cable(s) to ensure that it can be attached to the cable holder assembly 100 without interference. The nut 108 is then threaded on to the receptacle 104. The design of the nut 108 is such that when it is securely screwed on to the receptacle 104, it firmly presses against the tabs 114. The tabs 114 flex inward as a result, thus firmly gripping the grommet 106 and firmly holding the cable(s) in place. Further, the holder wing elements 102a-b are held in abutment by the nut 108. The cable holder 100 can then be connected to a larger assembly using clips 130 or other mechanisms.

To remove the cable, the steps of the above method should be performed in reverse.

When attached to the larger assembly, the cable holder 100 firmly holds the cable in place, such that a terminated end of the cable is unlikely to inadvertently detach from a connection point on the larger assembly. The cable holder 100 can easily be disassembled to allow for removal of the cable as needed.

Those skilled in the art will readily appreciate that having a cable holder constructed in accordance with the disclosed embodiment, allows a non-captive cable that has a large termination on its end to be readily clamped and avoids the need to have clamp components which are dimensioned to slide over the termination. Those skilled in the art will readily appreciate that the disclosed assemblies and methods can be used to secure captive cables as well as non-captive cables.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A cable holder assembly comprising:
a holder main body formed from a first wing element and second wing element, the first wing element being rotatably connected to the second wing element;
a first receptacle half extending from the first wing element;
a second receptacle half extending from the second wing element, the first receptacle half and second receptacle half being configured to form in combination a tubular receptacle defining an interior chamber when the first wing element is rotated into abutment with the second wing element;
a grommet configured to fit within the interior chamber; and
a nut formed from a first nut section and a second nut section, the second nut section being couplable to the first nut section, and the nut being configured to interface with the tubular receptacle in order to secure the grommet within the interior chamber.

2. The cable holder assembly of claim 1, wherein:
a continuous series of threads are formed about the tubular receptacle, and
a corresponding series of threads is formed within the nut such that the nut is threadably couplable to the tubular receptacle.

3. The cable holder assembly of claim 1, wherein:
the first nut section comprises at least one slot, and
the second nut section comprises at least one rail configured to interface with the at least one slot such that the second nut section is slidably couplable to the first nut section.

4. The cable holder assembly of claim 1, wherein the nut comprises a plurality of longitudinally extending ribs arranged circumferentially about an outer periphery of the nut.

5. The cable holder assembly of claim 1, wherein the grommet defines at least one central bore extending therethrough, and wherein at least one slit extends from a periphery of the grommet to the at least one central bore.

6. The cable holder assembly of claim 5, wherein exactly one slit extends from the periphery of the grommet to each respective central bore.

7. The cable holder assembly of claim 5, wherein the at least one central bore has a substantially circular cross section.

8. The cable holder assembly of claim 5, wherein the at least one central bore has a substantially oval cross section.

9. The cable holder assembly of claim 1, wherein the grommet is constructed of an elastomer.

10. The cable holder assembly of claim 9, wherein the elastomer is rubber.

11. The cable holder assembly of claim 1, the cable holder assembly further comprising a plurality of clips configured to connect to a separate assembly.

12. The cable holder assembly of claim 11, wherein the clips are part of a snap-fit connector.

13. The cable holder assembly of claim 1, wherein the first wing element and second wing element are connected via a hinge.

14. A method for securing at least one cable in a cable holder assembly, the method comprising:
placing the at least one cable in a grommet;
positioning the grommet between a first wing element of the cable holder assembly and a second wing element of the cable holder assembly, the first wing element being rotatably connected to the second wing element;
rotating the first wing element into abutment with the second wing element such that the grommet is held loosely within an interior chamber defined by a tubular receptacle, the tubular receptacle defined by a first receptacle half extending from the first wing element and a second receptacle half extending from the second wing element;
assembling a nut by coupling a first nut section to a second nut section; and
securing the grommet and the at least one cable within the interior chamber by coupling the nut to the tubular receptacle.

15. The method of claim 14, further comprising:
connecting the cable holder assembly to a larger assembly via a plurality of clips.

16. The method of claim 14, wherein the at least one cable is removed from the cable holder assembly by:
decoupling the nut from the tubular receptacle;
disassembling the nut;
rotating the first wing element out of abutment with the second wing element;
removing the grommet from the first wing element and the second wing element; and
removing the at least one cable from the grommet.

17. The method of claim 14, wherein the grommet defines at least one central bore extending therethrough, and wherein at least one slit extends from a periphery of the grommet to the at least one central bore.

18. The method of claim 17, wherein securing at least one cable in the grommet comprises:
widening the at least one slit; and
passing the at least one cable through the slit into the at least one central bore.

19. The method of claim 14, wherein assembling the nut comprises:
sliding at least one rail of the second nut section into at least one slot of the first nut section

20. The method of claim 14, wherein:
the tubular receptacle comprises a continuous series of threads,
the nut comprises a corresponding series of threads, and
wherein the nut is coupled to the tubular receptacle by rotating the nut about the tubular receptacle such that the corresponding series of threads engages with the continuous series of threads.
